(19) United States
(12) Patent Application Publication
(10) Pub. No.: US 2002/0168292 A1
(43) Pub. Date: Nov. 14, 2002

(54) Systems and methods for the high throughput preparation and analysis of chemical reactions

(76) Inventors: Donald Wayne Whisenhunt JR., Schenectady, NY (US); James Norman Cawse, Pittsfield, MA (US); Bruce Fletcher Johnson, Scotia, NY (US); Tracey Marie Jordan, Schenectady, NY (US); Ralph Joseph May, Niskayuna, NY (US); Eric Douglas Williams, Schenectady, NY (US); Kirill Vladimirovich Shalyaev, Clifton Park, NY (US); Michael Jarlath Brennan JR., Burnt Hills, NY (US); Carl Matthew Laurence Sundling, Guilderland, NY (US); James Lawrence Spivack, Cobleskill, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,634

(22) Filed: May 14, 2001

(51) Int. Cl. G01N 35/00

(52) U.S. Cl. 422/67; 700/266; 436/43

(57) ABSTRACT

Computerized systems and methods for planning, preparing, tracking, and analyzing a plurality of chemical reactions including a planner for planning how much of each of a plurality of materials is to be delivered to each of a plurality of reaction vessels; a delivery device for delivering a predetermined amount of each of the plurality of materials to each of the plurality of reaction vessels; a reaction device for reacting the plurality of materials disposed within each of the plurality of reaction vessels; a measuring device for testing and measuring the reacted contents of each of the plurality of reaction vessels; and an analyzer for analyzing the reacted contents of each of the plurality of reaction vessels to determine the amount of at least one component present in the reacted contents and to determine the relative performance of the materials disposed within each of the plurality of reaction vessels.

### BACKGROUND OF INVENTION

The present invention relates generally to combinatorial chemistry systems and methods and, more specifically, to systems and methods for the high throughput preparation and analysis of chemical reactions.

Since its introduction in 1970, combinatorial chemistry has become a popular research tool among scientists in many fields. High throughput and combinatorial screening for biological activity has been prevalent in the pharmaceutical industry for nearly twenty years and, more recently, high throughput and combinatorial screening for improved catalysts has enjoyed increasing popularity in the bulk chemical industry.

Most combinatorial work to date has focused on “solid phase” reactions. It is well known in the art that a wide variety of organic reactions may be carried out on substrates immobilized on resins. However, a substantial number of production-scale reactions are “liquid phase” or “mixed phase” and must be carried out in continuous flow reactor systems. Before the advent of high throughput and combinatorial approaches, catalyst testing was traditionally carried out in bench-scale units or large pilot plants. However, the high throughput and combinatorial screening of catalysts, reactants, products, and associated process conditions requires that a large number of reactions or catalytic systems be tested simultaneously. In certain applications, screening-level data may be generated using miniaturized batch reactors in conjunction with liquid handling robots that aliquot the appropriate catalysts and reactants to each of a plurality of reaction vessels, such as vials or wells. Although effective, this process may be time consuming and inefficient, as a large number of reactions must be planned, prepared, tracked, and analyzed.

Thus, what is needed are systems and methods that allow a large number of chemical reactions to be quickly and efficiently planned, prepared, tracked, and analyzed.

### SUMMARY OF INVENTION

The present invention addresses the above-identified problems and provides computerized systems and methods for planning, preparing, tracking, and analyzing chemical reactions in a quick and efficient manner, providing the high throughput necessary for the combinatorial discovery of novel catalysts, reactants, products, and reaction conditions.

In one embodiment, a computerized system for planning, preparing, tracking, and analyzing a plurality of chemical reactions includes a plurality of materials; a plurality of reaction vessels for receiving the plurality of materials; a planner for planning how much of each of the plurality of materials is to be delivered to each of the plurality of reaction vessels; a delivery device for delivering a predetermined amount of each of the plurality of materials to each of the plurality of reaction vessels; a reaction device for reacting the plurality of materials disposed within each of the plurality of reaction vessels; a measuring device for testing and measuring the reacted contents of each of the plurality of reaction vessels; and an analyzer for analyzing the reacted contents of each of the plurality of reaction vessels to determine the amount of at least one component present in the reacted contents and to determine the relative performance of the materials disposed within each of the plurality of reaction vessels.

In another embodiment, a computerized method for planning, preparing, tracking, and analyzing a plurality of chemical reactions includes the steps of planning how much of each of a plurality of materials is to be delivered to each of a plurality of reaction vessels; delivering a predetermined amount of each of the plurality of materials to each of the plurality of reaction vessels; reacting the plurality of materials disposed within each of the plurality of reaction vessels; testing and measuring the reacted contents of each of the plurality of reaction vessels; and analyzing the reacted contents of each of the plurality of reaction vessels to determine the amount of at least one component present in the reacted contents and to determine the relative performance of the materials disposed within each of the plurality of reaction vessels.

### BRIEF DESCRIPTION OF DRAWINGS

FIG. 1 is a flow chart of a method for the high throughput preparation and analysis of chemical reactions;

FIG. 2 is a functional block diagram of a system for the high throughput preparation and analysis of chemical reactions;

FIG. 3 is a functional block diagram of a computer's memory as it relates to the system of FIG. 2;

FIG. 4 is a functional block diagram of the computer's memory of FIG. 3, including several associated databases; and

FIG. 5 is a detailed flow chart of the method of FIG. 1.

### DETAILED DESCRIPTION

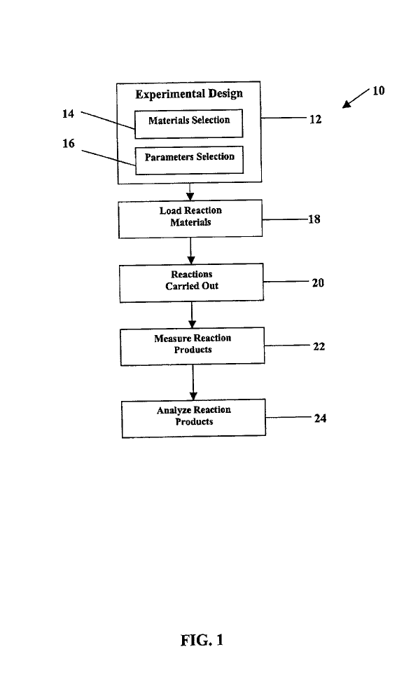

Referring to FIG. 1, a computerized method 10 for automatically planning, preparing, tracking, and analyzing a plurality of chemical reactions includes a series of steps beginning with the design of one or more experiments 12, each experiment including a plurality of independent chemical reactions. These reactions may be, for example, homogenous catalysis reactions or any other suitable type of chemical reaction. Optionally, the homogenous catalysis reactions may be carried out on a thin film and may include, for example, metal catalyzed reactions for converting phenol to diphenylcarbonate. The experimental design step 12 includes selecting from a database which of a plurality of materials will be used for each of the plurality of reactions 14 and selecting from a database the reaction parameters, or conditions, under which the reactions will be carried out 16. A computer is used to aid in this planning process. The plurality of materials used for each of the plurality of reactions form a combinatorial library and may include any suitable chemical. The plurality of materials generally include catalysts, reactants, and solvents. These materials are automatically delivered from a stored supply to a plurality of reaction vessels by a liquid handling device 18, such as a robotic fill device. The plurality of chemical reactions are then carried out in an appropriate reaction device 20. As discussed above, the reactions may be carried out under predetermined conditions, such as under elevated temperature and pressure, and in the presence of selected gasses, which may be automatically controlled and monitored by the computer. After the reactions are carried out, an automatic unloading device removes the reaction products and various measurements are taken using, for example, a gas chromatograph 22. These measurements are then analyzed, again with the aid of the computer, and the nature or degree of each of the plurality of reactions is determined 24. For example, the analysis step 24 allows a user to determine the products of each reaction or the effectiveness of a particular catalyst, as well as the relative performance of any variable associated with each reaction.

Thus, the computerized method 10 of the present invention allows a plurality of chemical reactions to be planned, prepared, tracked, and analyzed in an automated, quick, and efficient manner, providing the high throughput necessary for the combinatorial discovery of novel catalysts, reactants, products, and reaction conditions.

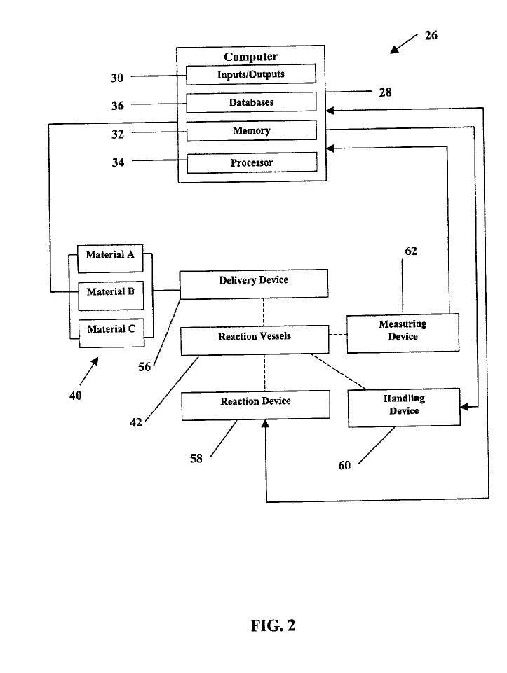

Referring to FIG. 2, a system 26 for planning, preparing, tracking, and analyzing a plurality of chemical reactions in an automated fashion includes a computer 28 for planning, operating, monitoring, and controlling each experiment. The computer 28 generally includes inputs/outputs 30, a memory 32, and a processor 34 for receiving, sending, storing, and processing signals and data to operate, monitor, record, and otherwise functionally control the operation of the system 26. The computer 28 may include software, hardware, firmware, and other similar components for functionally controlling the operation of the system 26. The computer 28 may be a single device, or it may be a plurality of devices working in concert. The computer 28 is preferably in communication with all of the other components of the system 26. Structurally, the input/output devices 30 may include, for example, a keyboard and a mouse for entering data and instructions into the computer 28. A video display allows the user to view what the computer 28 has accomplished. Other output devices 30 may include, for example, a printer, a plotter, a synthesizer, and speakers. The memory 32 generally includes a random-access memory (RAM) and a read-only memory (ROM). The memory 32 may also include other types of memory, such as programmable read-only memory (PROM), erasable programmable read-only memory (EPROM), and electrically erasable programmable read-only memory (EEPROM). The memory 32 also preferably includes an operating system that executes on the processor 34. The operating system performs basic tasks which include recognizing input from input devices 30, sending output to output devices 30, keeping track of files and directories, and controlling various peripheral devices. The memory 32 may also contain one or more databases 36. The processor 34 accepts data and instructions from the memory 32 and performs various calculations. The processor 34 may include an arithmetic logic unit (ALU), which performs arithmetic and logical operations, and a control unit, which extracts instructions from the memory 32. Optionally, the computer 28 may also include a modem or other network connection, a mass storage device, and any other suitable peripheral. The above-described computer 28 may take the form of a hand-held digital computer, a personal computer, a workstation, a mainframe computer, and a supercomputer.

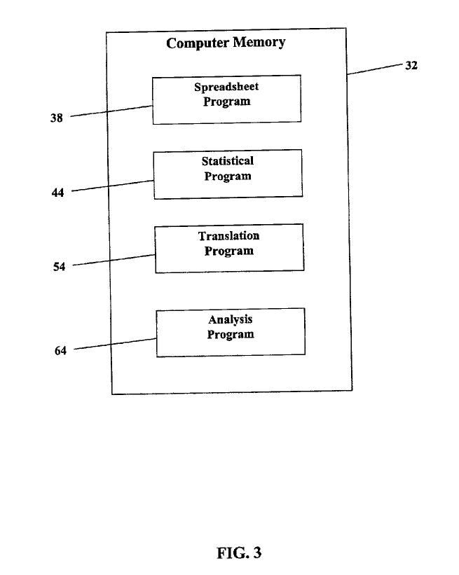

Referring to FIGS. 2 and 3, the computer's memory 32 preferably contains a number of programs for functionally controlling the operation of the system 26, including a spreadsheet program 38 for planning each experiment. The spreadsheet program 38 may be, for example, Microsoft Excel (MS Excel 97, Microsoft Corp., WA). The spreadsheet program 38 may utilize a number of macros written in, for example, Visual Basic (Visual Basic for Applications 97, Microsoft Corp., WA). The spreadsheet program 38 presents the user with information regarding the plurality of materials 40 that may be used for each of the plurality of chemical reactions and information regarding the plurality of reaction vessels 42 in which each of the plurality of chemical reactions may be carried out. Information regarding the plurality of materials 40 may be displayed, for example, at the top of each column of the spreadsheet's graphic display and may include, for example, each material's name, identification number, role, molecular weight, chemical formula, stock concentration, etc. Information regarding the plurality of reaction vessels 42 may be displayed, for example, at the left of each row of the spredasheet's graphic display and may include, for example, each reaction vessel's identification number, volume, replicate status, etc. The spreadsheet program 38 may also present the user with information regarding, for example, robotic position, environmental conditions, data made, etc. The remaining cells of the spreadsheet, which form a matrix that may be filled in by the user, represent the amount of each of the plurality of materials 40 to be delivered to each of the plurality of reaction vessels 42. These amounts are generally initially entered as moles or ratios. Other spreadsheet graphic display configurations may also be utilized. Information regarding the plurality of materials 40 may be entered into the spreadsheet program 38 by the user or, alternatively, may be imported into the computer's memory 32 via database software, such as Oracle database software (Oracle 7.3-8.0, Oracle Corp., CA), ACCESS, and SQL Server (Microsoft Corp., WA). Likewise, information regarding the plurality of reaction vessels 42 may be entered into the spreadsheet program 38 by the user or may be imported into the computer's memory 32 via database software. Optionally, the spreadsheet program 38 may also allow the user to select the experimental parameters, or conditions, under which a given experiment will be conducted. Such parameters may include, for example, the temperature and pressure under which the plurality of chemical reactions will be carried out, and the gasses which will be present. For example, for a metal catalyzed reaction for converting phenol to diphenylcarbonate, the reactions may be carried out at about 100 degrees C. and about 1,600 PSI, in the presence of about 7% oxygen in carbon monoxide. The period of time allowed for a given set of reactions to occur may also be entered.

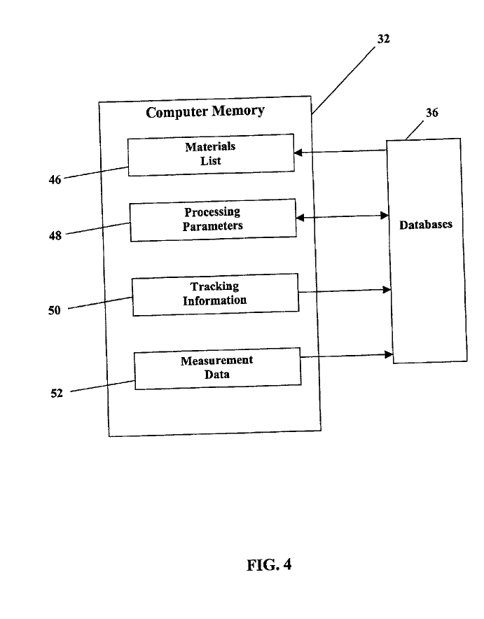

Thus, the spreadsheet program 38 allows the user to manually plan each experiment before it is conducted, based upon the user's experimental objectives and experience. A plurality of chemical reactions may be planned, each differing, for example, in the amount of a particular catalyst, reactant, or solvent present to thereby form a combinatorial experiment. Optionally, the computer's memory 32 may contain a statistical program 44, or other algorithm, for selecting the amount of each of the plurality of materials 40 to be delivered to each of the plurality of reaction vessels 42. FIG. 4 summarizes the information which may be imported to/exported from the computer's memory 32 via database software 36. This information may include, for example, a materials list 46, processing parameters 48, tracking information 50, and measurement data 52.

Referring again to FIGS. 2 and 3, once an experiment has been planned, the computer's memory 32 contains a translation program 54 for converting the information regarding the planned reactions into a protocol, or set of instructions, that may be understood by a liquid handling device 56. As discussed above, the liquid handling device 56 may be a robotic fill device or any other suitable device for delivering the specified amounts of the plurality of materials 40 to the plurality of reaction vessels 42. The liquid handling device 56 may be controlled by a controller, which may, optionally, be an integral part of the system computer 28. The liquid handling device 56 may also include a separate computer. Stock solutions of the plurality of materials 40 are loaded into the liquid handling device 56 and delivered to the plurality of reaction vessels 42 in accordance with the protocol established by the translation program 54.

As discussed above, the chemical reactions carried out using the systems and methods of the present invention may be, for example, homogenous catalysis reactions or any other suitable type of chemical reaction. These homogenous catalysis reactions may be carried out on a thin film and may include, for example, metal catalyzed reactions for converting phenol to diphenylcarbonate. Accordingly, the plurality of materials 40 may include any suitable catalysts, reactants, reagents, products, cofactors, or solvents. For example, the plurality of materials 40 may include metal complexes, such as palladium; phenol; and halide and amine sources soluble in phenol, such as chloride, bromine, sulfate, and other organic salts. Each of the plurality of materials 40 is generally in liquid form, however, if an appropriate solid handling device is used, the plurality of materials 40 may include solids as well. In general, the systems and methods of the present invention may be used to carry out homogenous and heterogeneous (liquid/solid/gas) reactions. Referring again to FIG. 1, the plurality of reaction vessels 42 may, in a preferred embodiment, include a plurality of vials disposed within a reaction plate that may, for example, be made of aluminum. The vials may be made of plastic, metal, or any other suitable material, and may include caps or lids which, optionally, may have slits or openings for allowing gas to enter the vials. Alternatively, the plurality of reaction vessels 42 may include a plurality of wells disposed within a standard microtiter plate. The plurality of reaction vessels 42 may also include any other container, chamber, defined volume, or area suitable for holding the plurality of materials 40. Generally, about 100 to about 200 reaction vessels 42 are utilized for a given experiment, allowing about 100 to about 200 independent chemical reactions to be carried out simultaneously. The plurality of reaction vessels 42 may contain labels fixedly attached to their exteriors, allowing the plurality of reaction vessels 42 to be tracked during the course of a given experiment. These labels may include chemical and temperature-resistant bar codes which may be read by a bar code scanner and the computer 28.

The plurality of chemical reactions are carried out in a reaction device 58, such as an autoclave. The reaction device 58 allows the chemical reactions to be carried out at an elevated temperature and pressure, and in the presence of selected gasses, over a predetermined period of time. The reaction parameters, or conditions, under which the plurality of chemical reactions are carried out may be set manually, controlled by a controller, or controlled by the computer 28. The reaction device 42 may also, optionally, communicate a reaction profile (i.e. a temperature profile, pressure profile, etc.) to the computer 28 and, specifically, the spreadsheet program 38 contained in the computer's memory 32. After the plurality of chemical reactions are carried out, the plurality of reaction vessels 42 are removed from the reaction device 58. This may be accomplished manually or the system 26 may include a robotic handling device 60 for this purpose. In general, the system 26 may include one or more robotic handling devices 60 for manipulating and transporting the plurality of reaction vessels 42, when necessary. The contents of the plurality of reaction vessels 42 are then tested and measured to determine what materials are present, how effective a particular catalyst is, how a given set of reaction conditions affect a given reaction, etc.

The measuring device 62 may be, for example, a gas chromatograph (such as an HP 6890 gas chromatograph, Agilent Technologies, CA). A gas chromatograph is a device commonly including a vaporizer, a separating column(s), a column oven, a detector, and a recorder for detecting and recording the presence of volatile compounds in a given sample. Optionally, the gas chromatograph may include an easy flash column(s) to accelerate sample analysis. The measuring device 62 may also be any other device suitable for testing or measuring the products, results, or outcomes of the plurality of chemical reactions. Output from the measuring device 62, which may include raw data or a plot with a series of peaks corresponding to the different materials present in a given sample, is communicated to the computer 28 and imported into the spreadsheet program 38 where it may be viewed, manipulated, and analyzed by the user. Preferably, the computer's memory 32 also contains an analysis program 64 operable for manipulating and analyzing the data in an automated fashion. The analysis program 64 may, for example, integrate the peaks, determine which are the peaks of interest (such as those corresponding to analytes), and summarize the products of each reaction. A suitable example of an analysis program 64 includes a custom written Visual Basic application. The analysis program 64 may also search for, identify, and correlate the peaks of standards, commonly utilized in an experiment to ensure proper experimental conditions and procedures. The output of the analysis program 64 may then be displayed by the computer 28 or the spreadsheet program 38, which may again include macros written in Visual Basic. Finally, the results may be exported to database software.

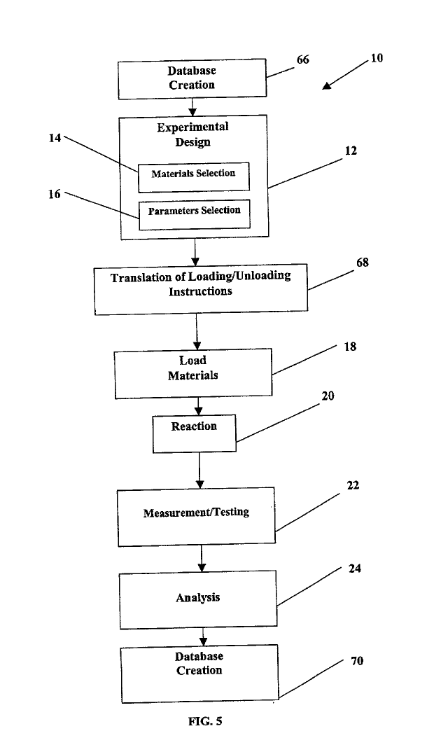

Referring to FIG. 5, as discussed above, the method 10 for planning, preparing, tracking, and analyzing a plurality of chemical reactions includes a series of steps beginning with experimental design 12, with each experiment including a plurality of chemical reactions. The experimental design step 12 includes selecting which of the plurality of materials 40 (FIG. 2) will be used for each reaction 14 and selecting the reaction parameters, or conditions, under which each of the plurality of chemical reactions will be carried out 16. Preferably, the computer 28 (FIG. 2), discussed above, is used to aid in the planning process. Specifically, the spreadsheet program 38 (FIG. 3) presents the user with information regarding the plurality of materials 40 that may be used for each chemical reaction and the plurality of reaction vessels 42 (FIG. 2) in which each reaction may be carried out. Information regarding the plurality of materials 40 may include, for example, each material's name, identification number, role, molecular weight, chemical formula, stock concentration, etc. Information regarding the plurality of reaction vessels 42, which are labeled for tracking purposes, may include, for example, each reaction vessel's identification number, volume, replicate status, etc. The remaining cells of the spreadsheet, which form a matrix that may be filled in by the user, represent the amount of each of the plurality of materials 40 to be delivered to each of the plurality of reaction vessels 42. The spreadsheet program 38 may also present the user with a series of menu-type screens, allowing the user to select, for example, the database(s) that will be used for planning a given experiment and a system operation mode (such as an experimental setup mode, a chemical planning mode, a results mode, a utilities mode, etc.). Information regarding the plurality of materials 40 may be entered into the spreadsheet program 38 by the user or, alternatively, prior to the experimental design step 12, may be entered into a database 66 and imported into the computer's memory 32 (FIGS. 2, 3, and 4). Optionally, the method 10 also allows the user to select the experimental parameters, or conditions, under which a given experiment will be conducted 16 using the spreadsheet program 38. Such parameters may include, for example, the temperature and pressure under which the plurality of chemical reactions will be carried out, the gasses which will be present, or the period of time which will be allowed for the reactions to occur.

Thus, the method 10 of the present invention allows the user to plan one or more experiments, each experiment consisting of a plurality of independent chemical reactions. Each reaction may differ, for example, in the amount of a particular catalyst, reactant, or solvent present. Optionally, a statistical program 44 (FIG. 3) may be used to select the amount of each of the plurality materials 40 to be delivered to each of the plurality of reaction vessels 42. Typically, an experiment includes about 100 to about 200 independent chemical reactions. In practice, however, each reaction may be duplicated to ensure that accurate conclusions are drawn. Thus, a given experiment typically only includes about 50 to about 100 different chemical reactions. A number of these reactions may also involve standards, which are used to ensure proper reaction conditions, processes, and procedures.

Following the experimental design step 12, information contained in the spreadsheet program 38 is translated into a protocol, or set of robotic instructions, that may be understood and executed by the liquid handling device 56 (FIG. 2), 68. This task is performed by the translation program 54 (FIG. 3) in two steps. The first step involves converting the amounts entered into the spreadsheet program 38, which are generally initially expressed in terms of moles or ratios, into volumes using information regarding the concentration of the stock solutions loaded into the liquid handling device 56. This may be done manually or in an automated fashion through the use of a macro, written in, for example, Visual Basic. These volumes may, optionally, be graphically displayed by the spreadsheet program 38. The second step then involves translating the volumes into a set of robotic instructions which are received and understood by the liquid handling device 56. The plurality of materials 40 are then delivered to the plurality of reaction vessels 42 in accordance with the established protocol 18. Optionally, the computer 28 or liquid handling device 56 may also contain a scaling subroutine for appropriately scaling the volumes presented in the spreadsheet program 38 before the liquid handling device 56 aliquots the plurality of materials 40 to the plurality of reaction vessels 42.

Following delivery 18, the plurality of reaction vessels 42, which are preferably vials that have been weighed when empty, are again weighed to determine the exact amount of each of the plurality of materials 40 that has been delivered to each of the plurality of reaction vessels 42 and to determine if any volume has been lost. Following weighing, the plurality of reaction vessels 42 are transported and disposed within the reaction plate, discussed above. This may be done manually or with the aid of a robotic handling device 60 (FIG. 2). The robotic handling device 60 may, optionally, be the same device as the liquid handling device 56 used to fill the plurality of reaction vessels 42. The labels fixedly attached to each of the plurality of reaction vessels 42 may also be scanned at this time. The reaction plate is then disposed within the reaction device 58 (FIG. 2) and the plurality of chemical reactions are carried out 20.

As discussed above, the plurality of chemical reactions may be carried out under predetermined conditions, such as under elevated temperature and pressure, and in the presence of selected gasses. Once a predetermined period of time has elapsed, the reaction plate is removed from the reaction device 58 and the plurality of reaction vessels 42 are removed from the reaction plate. Again, this may be done manually or with the aid of a robotic handling device 60. The label fixedly attached to each of the plurality of reaction vessels 24 may again be scanned for tracking purposes. The plurality of reaction vessels 42 are then, optionally, preprocessed and transported to the measuring device 62 (FIG. 2) where they are tested and measured 22 to determine, for example, what materials are present in each reaction vessel 42, how effective a particular catalyst was, how a given set of reaction conditions affected a given reaction, etc.

Preprocessing generally includes dissolving the contents of each of the plurality of reaction vessels 42, which may be a solid at this point, in a solvent. The solvent, which may, for example, be methyl-tert-butyl ether (MTBE), optionally, may contain one or more internal standards. Each mixture is filtered and transferred to a plurality of testing vessels. Optionally, in appropriate reactions, a derivatizing agent may be added to each of the testing vessels to, for example, cap the hydroxyl groups. Specifically, after the plurality of reaction vessels 42 are removed from the reaction device 58, they are placed in the robotic handling device 60 and a solvent (MTBE) with an internal standard(s) is added. The plurality of reaction vessels 42 are shaken, either manually or robotically, and the analytes are dissolved. These solutions are then filtered and transferred to a plurality of testing vessels for autosampler gas chromatography. BSTFA may be used to derivatize free hydroxyl groups to improve chromatographic resolution. The testing vessels may also be shaken to ensure complete derivatization.

The contents of each of the plurality of reaction vessels 42, now in a plurality of testing vessels, are then tested and measured by the measuring device 62, 22, which may, as discussed above, be a gas chromatograph. The measuring device 62 may also be any device suitable for testing or measuring the products, results, or outcomes of the plurality of chemical reactions. Output from the gas chromatograph, which typically includes raw data or a plot with a series of peaks corresponding to the different materials present in a given sample, is communicated to the computer 28 and imported into the spreadsheet program 38 where it may be viewed, manipulated, and analyzed by the user 24. Preferably, the computer's memory 32 also contains an analysis program 64 (FIG. 3) operable for manipulating and analyzing the data in an automated fashion. The analysis program 64 may, for example, integrate the peaks, determine which are the peaks of interest (such as those corresponding to analytes), and summarize the products of each reaction. The analysis program 64 may also search for, identify, and correlate the peaks of standards using a standard calibration curve. The amount of each analyte (expressed in moles or grams) is typically determined by examining the ratio of the analyte peak area to the internal standard peak area. The output of the analysis program 64 may then be displayed by the spreadsheet program 38, which may again include macros written in Visual Basic. Finally, the results may be exported to database software 70.

Thus, the nature or degree of each of the plurality of chemical reactions is determined. For example, the analysis step 24 allows a user to determine the products of each reaction or the effectiveness of a particular catalyst is. Combinatorially, different catalysts, catalyst amounts, and catalyst/reactant systems may be studied and compared. Thus, the method 10 of the present invention allows a plurality of chemical reactions to be planned, prepared, tracked, and analyzed in an automated, quick, and efficient manner, providing the high throughput necessary for the combinatorial discovery of novel catalysts, reactants, products, and reaction conditions.

Although the present invention has been described with reference to preferred embodiments, other embodiments may achieve the same results. Variations in and modifications to the present invention will be apparent to those skilled in the art and the following claims are intended to cover all such equivalents.

1. A computerized chemical reaction system, comprising:
a plurality of materials;
a plurality of reaction vessels for receiving the plurality of materials;
a planner for planning how much of each of the plurality of materials is to be delivered to each of the plurality of reaction vessels;
a delivery device for delivering the plurality of materials to each of the plurality of reaction vessels;
a reaction device for reacting the plurality of materials disposed within each of the plurality of reaction vessels;
a measuring device for testing and measuring the materials disposed within each of the plurality of reaction vessels; and
an analyzer for analyzing the materials disposed within each of the plurality of reaction vessels to determine the amount of at least one component present in the reacted contents and to determine the relative performance of the materials disposed within each of the plurality of reaction vessels.

2. The system of claim 1, further comprising a parameter planner for planning the conditions under which the plurality of materials are to be reacted in each of the plurality of reaction vessels.

3. The system of claim 1, further comprising a statistical algorithm for planning how much of each of the plurality of materials is to be delivered to each of the plurality of reaction vessels.

4. The system of claim 1, further comprising a translator for translating the amount of each of the plurality of materials to be delivered to each of the plurality of reaction vessels into a protocol that may be understood and executed by the delivery device.

5. The system of claim 1, further comprising a plurality of testing vessels in which the reacted contents of each of the plurality of reaction vessels are disposed for testing and measuring.

6. The system of claim 1, further comprising a standard analyzer for analyzing the test results and measurements to determine the amount of at least one standard present in the reacted contents of each of the plurality of reaction vessels.

7. The system of claim 1, wherein the reactions carried out in the plurality of reaction vessels are homogenous catalysis reactions.

8. The system of claim 1, wherein the reactions carried out in the plurality of reaction vessels comprise a combinatorial experiment.

9. A computerized system for planning, preparing, tracking, and analyzing a plurality of chemical reactions, the system comprising:
a plurality of materials;
a plurality of reaction vessels for receiving the plurality of materials;
a planner for planning how much of each of the plurality of materials is to be delivered to each of the plurality of reaction vessels;
a parameter planner for planning the conditions under which the plurality of materials are to be reacted in each of the plurality of reaction vessels;
a translator for translating the amount of each of the plurality of materials to be delivered to each of the plurality of reaction vessels into a protocol that may be understood and executed by a delivery device;
a delivery device for delivering the plurality of materials to each of the plurality of reaction vessels;
a reaction device for reacting the plurality of materials disposed within each of the plurality of reaction vessels;
a measuring device for testing and measuring the materials disposed within each of the plurality of reaction vessels; and
an analyzer for analyzing the materials disposed within each of the plurality of reaction vessels to determine the amount of at least one component present in the reacted contents and to determine the relative performance of the materials disposed within each of the plurality of reaction vessels.

10. The system of claim 9, further comprising a statistical algorithm for planning how much of each of the plurality of materials is to be delivered to each of the plurality of reaction vessels.

11. The system of claim 9, further comprising a plurality of testing vessels in which the reacted contents of each of the plurality of reaction vessels are disposed for testing and measuring.

12. The system of claim 9, further comprising a standard analyzer for analyzing the test results and measurements to determine the amount of at least one standard present in the reacted contents of each of the plurality of reaction vessels.

13. The system of claim 9, wherein the reactions carried out in the plurality of reaction vessels are homogenous catalysis reactions.

14. The system of claim 9, wherein the reactions carried out in the plurality of reaction vessels comprise a combinatorial experiment.

15. A computerized chemical reaction method, comprising the steps of:
planning how much of each of a plurality of materials is to be delivered to each of a plurality of reaction vessels;
delivering a predetermined amount of each of the plurality of materials to each of the plurality of reaction vessels;
reacting the plurality of materials disposed within each of the plurality of reaction vessels;
testing and measuring the reacted contents disposed within each of the plurality of reaction vessels; and
analyzing the reacted contents disposed within each of the plurality of reaction vessels to determine the amount of at least one component present in the reacted contents and to determine the relative performance of the materials disposed within each of the plurality of reaction vessels.

16. The method of claim 15, further comprising the step of planning the reaction parameters under which the plurality of materials are to be reacted in each of the plurality of reaction vessels.

17. The method of claim 15, further comprising the step of utilizing a statistical algorithm to plan how much of each of the plurality of materials is to be delivered to each of the plurality of reaction vessels.

18. The method of claim 15, further comprising the step of translating the amount of each of the plurality of materials to be delivered to each of the plurality of reaction vessels into a protocol that may be understood and executed by a delivery device.

19. The method of claim 15, further comprising the step of providing a reaction device in which the plurality of materials are reacted in each of the plurality of reaction vessels.

20. The method of claim 15, further comprising the step of providing a plurality of testing vessels in which the reacted contents of each of the plurality of reaction vessels are disposed for testing and measuring.

21. The method of claim 15, further comprising the step of preprocessing the reacted contents of each of the plurality of reaction vessels for testing and measuring.

22. The method of claim 15, further comprising the step of providing a measuring device for testing and measuring the reacted contents of each of the plurality of reaction vessels.

23. The method of claim 15, further comprising the step of analyzing the test results and measurements to determine the amount of at least one standard present in the reacted contents of each of the plurality of reaction vessels.

24. The method of claim 15, wherein the reactions carried out in the plurality of reaction vessels are homogenous catalysis reactions.

25. A computerized method for planning, preparing, tracking, and analyzing a plurality of chemical reactions, the method comprising the steps of:
planning how much of each of a plurality of materials is to be delivered to each of a plurality of reaction vessels;
planning the reaction parameters under which the plurality of materials are to be reacted in each of the plurality of reaction vessels;
translating the amount of each of the plurality of materials to be delivered to each of the plurality of reaction vessels into a protocol that may be understood and executed by a delivery device;
delivering a predetermined amount of each of the plurality of materials to each of the plurality of reaction vessels;
reacting the plurality of materials disposed within each of the plurality of reaction vessels;
preprocessing the reacted contents of each of the plurality of reaction vessels for testing and measuring;
testing and measuring the reacted contents disposed within each of the plurality of reaction vessels; and
analyzing the reacted contents disposed within each of the plurality of reaction vessels to determine the amount of at least one component present in the reacted contents and to determine the relative performance of the materials disposed within each of the plurality of reaction vessels.

26. The method of claim 25, further comprising the step of utilizing a statistical algorithm to plan how much of each of the plurality of materials is to be delivered to each of the plurality of reaction vessels.

27. The method of claim 25, further comprising the step of providing a reaction device in which the plurality of materials are reacted in each of the plurality of reaction vessels.

28. The method of claim 25, further comprising the step of providing a plurality of testing vessels in which the reacted contents of each of the plurality of reaction vessels are disposed for testing and measuring.

29. The method of claim 25, further comprising the step of providing a measuring device for testing and measuring the reacted contents of each of the plurality of reaction vessels.

30. The method of claim 25, further comprising the step of analyzing the test results and measurements to determine the amount of at least one standard present in the reacted contents of each of the plurality of reaction vessels.

31. The method of claim 25, wherein the reactions carried out in the plurality of reaction vessels are homogenous catalysis reactions.
